(19) United States
(12) Patent Application Publication
(10) Pub. No.: US 2003/0110835 A1
(43) Pub. Date: Jun. 19, 2003

(54) Sewer leak locator device and method

(76) Inventor: Richard Williams, Raleigh, NC (US)

Correspondence Address: JINAN GLASGOW, P O BOX 28539, RALEIGH, NC, 276118539

(21) Appl. No.: 10/017,112

(22) Filed: Dec. 14, 2001

(51) Int. Cl. G01M 3/04

(52) U.S. Cl. 73/40.7

(57) ABSTRACT

A mobile device for controlled generation and introduction of a detectable gaseous substance into conduits for detecting unsealed opening location and a method for using same. The device is formed and includes a means for air introduction into a container in which a detectable gaseous substance is generated or introduced, and a gas delivery device, such as a flexible hose, for delivering the mixture of air and detectable gaseous substance to the conduit to be tested for leaks.

### BACKGROUND OF THE INVENTION

(1) Field of the Invention

The present invention relates generally to leak detection, and more particularly, to a mobile device and method for detecting leaks in conduits, plumbing, pipelines and duct systems.

(2) Description of the Prior Art

Typically, prior art consists of pipeline testing using inflatable devices or video cameras for detecting leaks.

U.S. Pat. No. 4,694,695, issued Sep. 22, 1987 to Sewell, et al. for a Sewer pipe smoke blocking device teaches an inflatable bladder that can be inserted into pipe to seal off sections of the pipe so that one can introduce smoke and test for leaks in that section.

U.S. Pat. No. 4,402,213 issued Sep. 6, 1983 to Hogan for a Method and device for detecting and locating leaks in pipelines teaches a leak locator probe to be transported along a length of pipe. The probe includes a tube open at one end. An aperture provides airflow passage between interior and exterior of tube/interior walls of pipe. The probe is inserted into pipe sealing contact, and then the pipe is pressurized. Where the leak occurs, air flows through the aperture. This method and device could be used only for above ground piping. Ultrasound detection might be able to detect a concealed leak slab.

U.S. Pat. No. 5,467,640 issued Nov. 21, 1995 to Salinas for a Pipeline testing and leak locating apparatus and method teaches the use of an inflatable test ball and remotely operated camera. Segments of a pipe are isolated by snaking the ball and camera to a point, inflating test ball to seal off segment and viewing quality of seal with camera.

U.S. Pat. No. 4,913,558 issued Apr. 3, 1990 to Wettervik, et al. for a Method and apparatus for detecting leaks and other defects on sewers and the like channels teaches the detection of leaks using an infrared video camera moved internally through the pipe. Scanning device senses temperature deviations where cooler extraneous water due to leaks inflows into sewer.

U.S. Pat. No. 4,651,558 issued Mar. 24, 1987 to Martin et al. for a Method and apparatus for inspecting lateral lines teaches using a video camera inserted into a pipeline for viewing its interior and detecting leaks. This method in particular is difficult to use with branching circuits.

In addition to the technical difficulties cited, these devices and method require considerable investment and or time to implement, and are therefore expensive to use. Additionally, some of the prior art devices and method are hard to use without hands-on knowledge, and therefore require trained, skilled personnel, which is an additional expense incurred prior to implementation of the device and/or method. Thus, there remains a need for a leak detection device that is easy to use and inexpensive to operate.

### SUMMARY OF THE INVENTION

The present invention is directed to a mobile device for controlled generation and introduction of detectable gaseous substance into conduits for detecting unsealed opening location.

The present invention is further directed to a method for detecting leaks in conduits and plumbing using a mobile device for the controlled generation and introduction of detectable gaseous substance into conduits for detecting unsealed opening location.

Thus, the present invention provides a mobile device and method for detecting leaks in conduits and plumbing, more specifically, a mobile device for the controlled generation and introduction of detectable gaseous substance into conduits for detecting unsealed opening location and a method for using same.

Accordingly, one aspect of the present invention is to provide a sewer leak locator device that includes an air introduction means, connected to a container in which a detectable gaseous substance detectable by at least one sense is generated by a detectable gaseous substance generator; the container further connected to a gas delivery device; thereby providing a mixture of pressurized air and a detectable gaseous substance for introduction into a conduit system for the detection of leaks.

Another aspect of the present invention is to provide a method of use of the present invention to locate leaks in a conduit system including the steps of attaching the gas delivery device to the conduit system; generating a detectable gaseous substance in the container; turning on the blower; and inspecting the conduit system and area around the conduit system for leaks.

These and other aspects of the present invention will become apparent to those skilled in the art after a reading of the following description of the preferred embodiment when considered with the drawings.

### BRIEF DESCRIPTION OF THE DRAWINGS

FIG. 1 is a diagrammatic view of a gaseous leak locator device constructed according to the present invention.

### DETAILED DESCRIPTION OF THE PREFERRED EMBODIMENTS

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

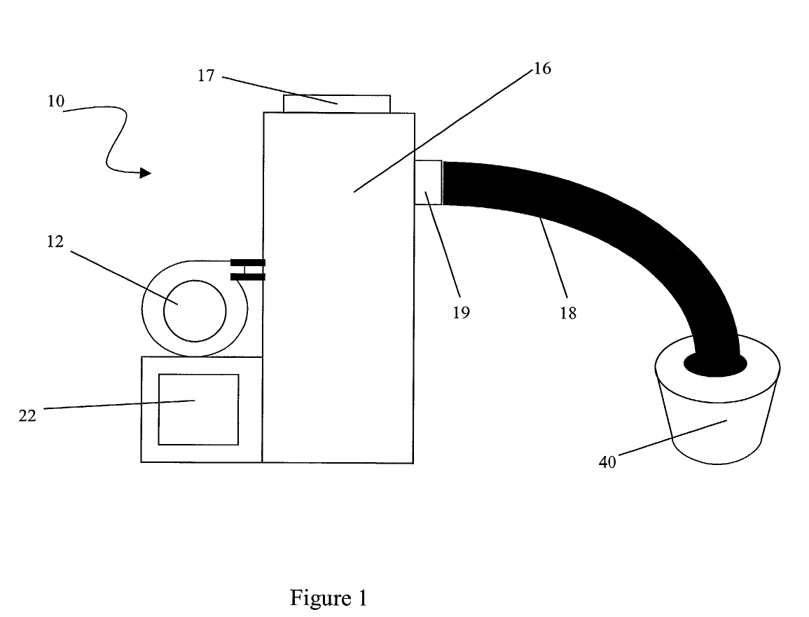

Referring now to the drawings in general, the illustrations are for the purpose of describing a preferred embodiment of the invention and are not intended to limit the invention thereto. As best seen in FIG. 1, the device according to the present invention, generally referenced as 10, includes a means for air introduction 12 into the device, the air introduction means 12 connected to a container 16 with a removable, sealable lid 17 in which a detectable gaseous substance (not shown) is generated or introduced, and is also connected to a gas delivery device 18 for delivering the mixture of air and detectable gaseous substance to a conduit or pipe system, e.g. a plumbing pipe network or system, to be tested for leaks. A storage bin 22 may also be attached to the container

The air introduction means 12 is preferably a blower or a compressed gas supply; generally, any controllable source for introducing, directing or channeling a gas or air supply. It is positioned prior to the container 16 that generates the detectable gaseous substance, since this substance is frequently noxious or corrosive. For example, smoke may be generated within the container; by way of example, a smoke bomb may be used as the smoke source. Importantly, since smoke from the combustion of materials is caustic, and will corrode bearings and other non-resistant materials it contacts, it is preferable to avoid generating smoke at the intake of the blower such that it will be aspirated by the blower and introduced into the system, as this will cause the blower to eventually fail. Therefore, the air introduction means of the present invention preferably blows air through a container in which the detectable gaseous substance is introduced, rather than aspirate air through the intake.

Where a blower is used, the operator of the device should check to confirm that the airflow generated by the blower is sufficient to blow the smoke throughout the system and that the rate of generation of the detectable gaseous substance is sufficient to avoid overly diluting the detectable gaseous substance. If the detectable gaseous substance is too dilute, observers will not be able to detect leaks accurately.

For lines up to 4″ internal diameter, the blower should generate from 100-225 cubic feet per minute (CFM). The goal is to locate the leak with minimum impact on inhabited buildings, for example supermarkets, office buildings, and domestic dwellings. Therefore the device operator would start with one 30 second smoke bomb. If leak is not located the operator would then try a 60 second bomb and so on. If the leak is not located after a 180 second smoke bomb, the operator would then seek out another cause of the problem. The same process is used in larger lines with the CFM and smoke bomb sizes being increased as needed.

Additionally, the device should not overly pressurize a conduit system, especially a conduit system that contains water traps, as high pressure can blow out traps, and therefore give a false reading. Thus the device and method according to the present invention is constructed and configured such that the airflow of the device can be varied to supply sufficient air to a conduit or plumbing system and the detectable gaseous substance generation can be varied to supply sufficient detectable gaseous substance to the air such that the leak location can be determined by observers.

In a preferred embodiment according to the present invention, the blower is a shaded pole blower, supplied by Dayton Electric Manufacturing Co. of Niles, Ill. For a low-pressure applications, such as sewers, HVAC, electrical conduit, the blower utilized supplies 100-225 CFM at 2870 RPM and 0.0 inches of static pressure. The blower is preferably a variable speed blower for testing a multiplicity of conduit systems that vary highly in their total volume and pressure rating. The leak locator device according to the present invention as described is designed for use in smaller dwelling plumbing systems. Larger diameter tube systems, for example 8 inch internal diameter piping and greater, such as community sewer systems, will need a larger blower in order to supply appropriate air flow to both systems when required.

In high-pressure conduit systems, the air introduction means may include a compressed gas source. For example, a compressed nitrogen tank or an air compressor can be connected to the device to supply nitrogen gas at high pressure. In this configuration, a high pressure leak locator device is capable of locating leaks in evacuated water pipes, refrigeration coils, LP or natural gas lines, and the like.

The air or gas generated by the air introduction means is routed into the container, as shown in FIG. 1. This container contains an exit opening 19 and is sealed such that the introduced air or gas must exit through the exit opening. The container also has a removable, sealable cover 17 through which the detectable gaseous substance generator can be introduced. The detectable gaseous substance is preferably one that can be detected via the senses, e.g., by sight or by smell. For example, visibly detectable substances, such as particulate matter, more preferably smoke particulate, are generated in the container. For example, one or more smoke bombs can be ignited and placed in the container to generate smoke. Alternatively, an odorous substance, such as hydrogen sulfide, which can be detected via the olfactory senses, can be released into the container. Other substance can also be used, such as a detectable freon mixture. More preferably, a combination of a visible substance and an odorous substance can be generated in the container. For example, certain smoke bombs, such as the SUPERIOR smoke bomb supplied by Superior Signal Co., Inc. of Spotswood, N.J. produces both visible and odorous substances. Other types of compounds may be used as the detectable gaseous substance, such as compounds that are detectable via excitement with ultraviolet light or are visible through the aid of infrared glasses.

The container can be made from a variety of materials; however, the nature of the detectable gaseous substance should be taken into consideration when designing the container, as these substances may be corrosive to certain materials. Preferably, the container is made from a material selected from the group consisting of stainless steel, enameled steel, glass, plastic, and combinations thereof.

In the preferred embodiment of the present invention, smoke from a smoke bomb is used as the detectable gaseous substance. Smoke is caustic, and therefore will corrode glass, some plastics, aluminum, and iron with long-term exposure. For this reason, the preferred embodiment of the present invention is made of stainless steel or enameled steel.

In a prototypical model of the present invention, the container is cylindrical with dimensions of 20 to 30″ high and 5 to 15″ diameter and is formed of stainless steel. The device is portable because of its size and can include wheels for mobility.

The gas delivery device routes the air and detectable gaseous substance mixture to the conduit to be tested for leaks. Preferably, the gas delivery device is a flexible hose. The diameter, length, and rated pressure of the hose are preferably based on the application. For example, high pressure and low volume applications require smaller diameter hose capable of withstanding higher pressures, whereas low pressure and high volume applications require larger diameter hose, but which is not necessarily of a high pressure capacity. In a preferred embodiment, the hose is a flexible 1¼″ hose approximately six (6) feet long and is supplied by ShopVac Corp. of Williamsport Pa.

Because the gas delivery device is adaptable for connection to a multiplicity of conduit sizes, an adapter is preferably fitted to the end of the gas delivery device such that the gas delivery device can attach to a multiplicity of conduit sizes and form a sufficiently hermetic seal with these to prevent the escape of the introduced air and detectable gaseous mixture. In a prototypical model of the present invention, the adapter used included a foam cylinder 40, shown in FIG. 1, the flexible hose being inserted into one end as shown and the other, tapered end being inserted into the conduit to be tested.

The method of use of the present invention to locate leaks in a conduit system involves the following steps: deactivating any alarms, such as smoke alarms, that might be triggered by the detectable gaseous substance; capping all known vents of the conduit system; attaching the gas delivery device to the conduit system; starting or activating the smoke bombs or other detectable gaseous substance generator; activating the blower; and inspecting the conduit system and area around the conduit system for leaks.

Potential applications of this invention include leak detection in plumbing and sewer lines, electrical conduits, HVAC vents, heat exchangers, and telephone conduits. The present invention can also be used for the detection of dry traps. These are difficult to find, since they are normally concealed. The present invention can be used to detect improper construction, such as when pipes are improperly terminated or not properly sealed. The system can also be used to locate unknown terminations of electrical conduits overhead or underground

Certain modifications and improvements will occur to those skilled in the art upon a reading of the foregoing description. All modifications and improvements have been deleted herein for the sake of conciseness and readability but are properly within the scope of the following claims.

I claim:

1. A device for detecting leaks in a conduit system comprising:
an air introduction means, connected to a container in which a detectable gaseous substance detectable by at least one sense is generated by a detectable gaseous substance generator; the container further connected to a gas delivery device;
thereby providing a mixture of pressurized air and a detectable gaseous substance for introduction into a conduit system for the detection of leaks.

2. The device as in claim 1 wherein the air introduction means is a blower.

3. The device as in claim 2 wherein the blower is a shaded pole blower.

4. The device as in claim 2, wherein the blower is a variable speed blower.

5. The device as in claim 1, wherein the air introduction means includes compressed gas.

6. The device as in claim 1, wherein the detectable gaseous substance is visibly detectable.

7. The device as in claim 6, wherein the visibly detectable substance is a particulate.

8. The device as in claim 7, wherein the visibly detectable substance is smoke.

9. The device as in claim 1, wherein the visibly detectable substance generator includes a smoke bomb.

10. The device as in claim 1, wherein the detectable gaseous substance is detectable by the olfactory senses.

11. The device as in claim 1, wherein the detectable gaseous substances is detectable by a combination of senses.

12. The device as in claim 7, wherein the container is manufactured of a corrosion-resistant material.

13. The device as in claim 12, wherein the material is stainless steel.

14. The device as in claim 12, wherein the material is enameled steel.

15. The device as in claim 1, wherein the container is cylindrical with dimensions of 20 to 30″ height and 5 to 15″ diameter and is formed of stainless steel.

16. The device as in claim 1, wherein the gas delivery device is a flexible hose.

17. The device as in claim 16, wherein the flexible hose is a 1¼″ hose approximately 6 feet long.

18. The device as in claim 1, further including an adapter for hermetically alternately connecting the gas delivery device to a multiplicity of conduit sizes.

19. A method for detecting and locating leaks in a conduit system comprising the steps of:
attaching a leak locator device to the conduit system;
generating a detectable gaseous substance in the leak locator device;
turning on the blower; and
inspecting the conduit system and area around the conduit system for leaks.

20. The method according to claim 19, wherein the leak locator device comprises:
an air introduction means, connected to a container in which a detectable gaseous substance detectable by at least one sense is generated by a detectable gaseous substance generator; the container further connected to a gas delivery device; thereby providing a mixture of pressurized air and a detectable gaseous substance for introduction into a conduit system for the detection of leaks.

21. The method according to claim 19, further including the step of capping all known vents of the conduit system prior to generating a detectable gaseous substance in the leak locator device.
